(19) United States
(12) Patent Application Publication
(10) Pub. No.: US 2026/0196025 A1
(43) Pub. Date: Jul. 9, 2026

(54) AUTOMATIC ARTIFICIAL INTELLIGENCE ALERTING SYSTEM FOR TIMELY DETECTION AND TRACKING OF OIL SPILLS

(71) Applicant: Saudi Arabian Oil Company, Dhahran (SA)

(72) Inventors: Frankly Leonardo Toro Gonzalez, Thuwal (SA); Ahmed Aljarro, Thuwal (SA); Ali Al Shehri, Thuwal (SA); Mohmmed T. Abdulmohsin, Dhahran (SA)

(21) Appl. No.: 19/011,070

(22) Filed: Jan. 6, 2025

(51) Int. Cl. G06V 10/77; G06Q 10/0631; G06V 10/80; G06V 20/13; G06V 20/17

(52) U.S. Cl. CPC G06V 10/7715; G06Q 10/0631; G06V 10/803; G06V 20/13; G06V 20/17; G06V 2201/10

(57) ABSTRACT

Systems and methods to collect data for a region of interest within an onshore zone. The data includes remote sensing images of the region of interest and related metadata. The remote sensing images of the region of interest and the related metadata are integrated with weather data to create a fused dataset. An artificial intelligence model is used to analyze the fused dataset and determine characteristics of an oil spill. Based on the oil spill characteristics, a plan to address the oil spill's impact is developed and implemented.

### TECHNICAL FIELD

The present disclosure is generally related to material detection based on remote sensing images and, more specifically, to computer-implemented methods, software, and systems for detection and tracking of oil spills.

### BACKGROUND

Oil spills can have substantial economic and environmental implications. Oil spills are particularly problematic when presenting a risk of contaminating water and soil environments. A technical challenge in detecting oil spills within water environment is related to the variety of reactions between different oil types and water. Some oil types spread as a thin layer, while other oil types mix with water, increasing the difficulty of detection. As an added factor, the volume of oil spill within a particular time interval can also affect the detection and tracking. The detection of onshore oil spills presents a technical challenge due to the nature of the discharge, which can be sporadic, continuous, or low quantity; making early identification difficult. In addition to the oil types and the oil spill generation source characteristics, the detection of oil spills and corresponding movement patterns can also be affected by environmental factors. For example, wind speed, wind direction, product temperature, environment temperature, vegetation, and topography can significantly impact the oil spill patterns and their detection within one or another environment.

### SUMMARY

Implementations of the present disclosure are directed to material detection based on remote sensing images. More particularly, implementations of the present disclosure are directed to computer-implemented methods, software, and systems for detection and tracking of oil spills.

In some implementations, a computer-implemented method includes: receiving data corresponding to a region of interest, the data including remote sensing images of the region of interest and respective metadata, the region of interest being within an onshore zone, integrating the remote sensing images of the region of interest and the respective metadata with meteorological data to generate fused data, determining, by processing the fused data, using an artificial intelligence model, features of an oil spill, and identifying an action plan to remedy an effect of the oil spill based on the features of the oil spill.

The foregoing and other implementations can each optionally include one or more of the following features, alone or in combination. In particular, implementations can include all the following features:

In a first aspect, combinable with any of the previous aspects, wherein the features of the oil spill can include spread direction and pollutant type. Identifying the action plan can include determining a risk associated with the spread direction, and generating an alert indicative of the risk associated with the spread direction. The spread direction can be determined based on segmentation masks and based on change detection. The remote sensing images can include satellite and/or drone optical, synthetic aperture radar (SAR), interferometric SAR (InSAR), infrared (IR), and multi/hyperspectral images. The artificial intelligence model can be trained using historical data or synthetic generated data along with techniques including transfer-learning, multi-task learning, continual learning, supervised learning, un-supervised learning, or domain-adaptation. The effect of the oil spill can be determined relative to one or more points of interests and wherein identifying the action plan to remedy the effect of the oil spill includes activating an equipment to clean or protect the one or more points of interests.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

Implementations described in the present disclosure, provide an accurate identification and masking of oil spills, for example, facilitating the application of clustering algorithms to pure pixels that represent distinct and homogenous material features. The described approach efficiently removes the noise associated with oil spills, providing the advantage of significantly improving the separation of clusters in the feature space, resulting in more precise and stable cluster formation. The cluster formation improvement of the described implementations is particularly significant for density-seeking hierarchical clustering algorithms, such as single-link clustering, which are sensitive to noise, especially in the region between clusters. Another advantage of the described technology is that it ensures that only high-quality, pixels corresponding to oil spills are considered at all scales in the image, the segmentation process becoming more robust, producing clearer and more meaningful segmentations that better represent the range of materials in the image. The described technology substantially improves over existing methods in that it retains spectra representing pure materials that lie close to the boundaries of the pure clusters. The described technology provides a valuable tool for accurate optical, SAR, InSAR, IR, or multi/hyperspectral image analysis and interpretation with respective myriad applications. Another advantage of the described technology is that the described mapping of oil spills can trigger automatic operations for systems and machines configured to maintain environmental safety and system operability.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure.

FIG. 1B is a block diagram of a portion of the example system that can be used to execute implementations of the present disclosure.

FIG. 2A illustrates an example of an aerial image acquired at a first time point, according to some implementations of the present disclosure.

FIG. 2B illustrates an example output data including detected oil distribution and movement patterns, according to some implementations of the present disclosure.

FIG. 3 is a flowchart illustrating an example process for oil spill detection, in accordance with some example embodiments.

FIG. 4 depicts a block diagram illustrating a computing system, in accordance with some example embodiments.

When practical, like labels are used to refer to same or similar items in the drawings.

### DETAILED DESCRIPTION

The following detailed description describes techniques for material detection based on remote sensing images. More particularly, implementations of the present disclosure are directed to computer-implemented methods, software, and systems for detection and tracking of oil spills. The described implementations provide generation of fused data by integration of satellite and/or drone collected images, respective metadata, and meteorological data. The remote sensing images can include satellite images and/or drone collected images of an aera of interest at multiple points in time. The change of the oil distribution within the region of interest can be induced by several multiple factors, including environmental and metrology conditions. The fused data is processed, using an identification, detection, and/or classification model, to determine oil spill patterns. The map of oil spill patterns facilitates automatic action initiation according to respective response plans.

Oil spills, whether from major tankers or small pipelines and refineries, can have impact on the surrounding environment. Many traditional detection algorithms of oil spill patterns have been focused on offshore spills. Onshore oil spills have been analyzed less than offshore spills, resulting in limited progress concerning the contamination assessment stemming from extraction and refining activities. The onshore operations can involve sporadic or continuous, with low-quantity contaminant release, making early detection challenging.

Addressing the described challenges and limitations, the techniques of the present disclosure provide a viable solution for onshore oil spills, mainly through remote sensing imagery. The described approach provides a rapid, resource-efficient technique applicable to all coverage scales for the detection of oil spills, substantially benefiting the oil and gas industry, as well as all other sectors. An advantage of the described implementations is that remote sensing facilitates (near) real-time monitoring capabilities for spill events, depending on the delay between data acquisition and its availability, enabling prompt responses. As another advantage, the described implementations integrate advanced technologies, such as digital monitoring tools, modern artificial intelligence analytics, and advanced sensors that can further strengthen the effectiveness of implementing actions to address oil spill identification and detection, minimizing their impact. The described implementations advantageously facilitates the development of comprehensive and immediate response plans. The response plans can include efficient notification procedures and the integration of advanced technologies like digital monitoring tools, identification, detection, classification, and predictive analytics, and automatic machine activation for removing oil spills that also minimize the effects of the detected oil spills.

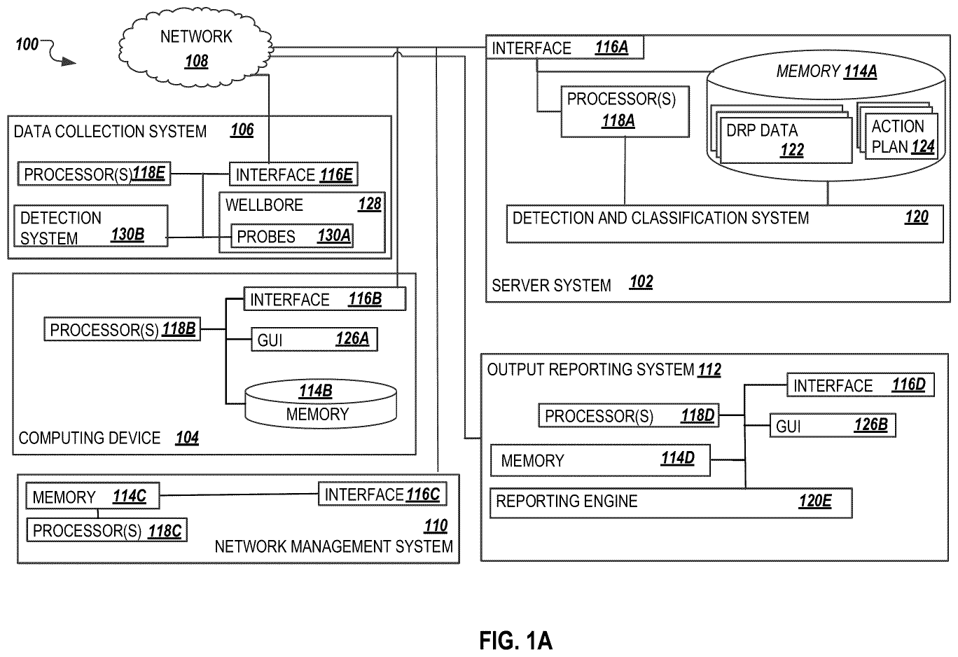

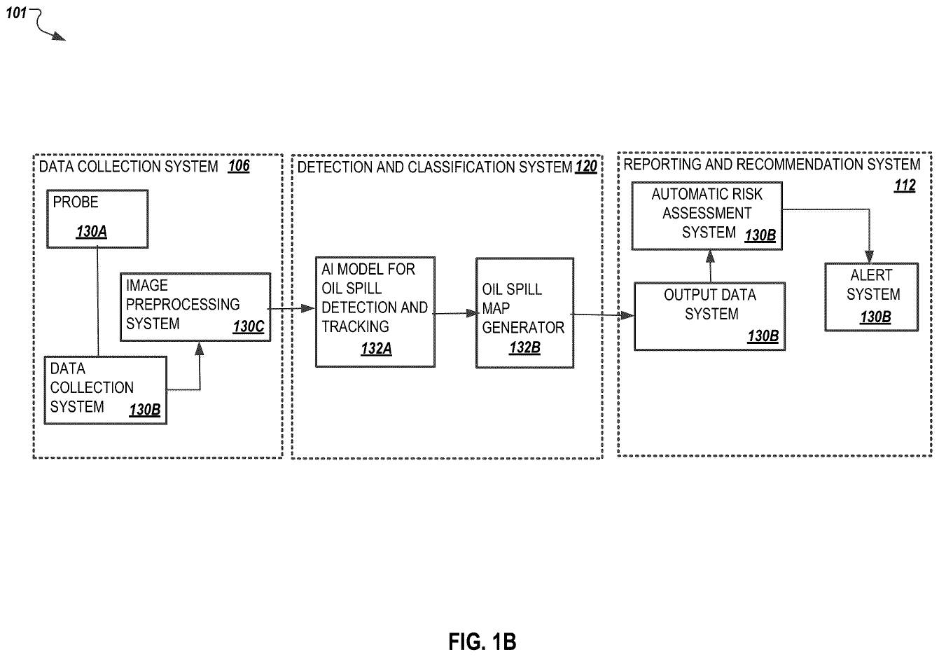

FIG. 1A is a block diagram illustrating an example system 100 that can be used to execute implementations of the present disclosure. For example, example system 100 can be configured to execute oil spill pattern detection algorithms based on remote sensing image processing. The illustrated example system 100 includes or is communicably coupled with a server system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages oil spill pattern detection algorithms for aerial image processing. In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes.

For example, the server system 102 includes a memory 114A, an interface 116A, a processor 118A, and a detection and classification system 120 and an action plan engine 120B. The memory 114A can include remote sensing images 122 and action plans 124. The aerial images 122 include images collected by and received from the data collection system 106. The aerial images 122 can include images detected by aerial sensors attached to aerial devices 128 (e.g., satellites and/or drones). The remote sensing images 122 can be processed by the detection and classification system 120A to generate oil distribution and pattern movement maps that are processed by the action plan engine 120B to generate action plans 124. The action plans 124 in the memory 114A can include action plan documents defining remedial operations performed by systems and machine for management and redistribution of materials including oil within onshore regions.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1A. Each of the computing device 104, the network management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including a display of the material maps and action plan operations selected based on the oil spills. The GUIs 126A, 126B each interface with at least a portion of the example system 100 for any suitable purpose, including generating a visual representation of the remote sensing images 122 collected by the data collection system 106, the material maps generated by the server system 102, or data stored by the server system 102, such as remote sensing images 122 and action plans 124, respectively. In particular, the GUIs 126A, 126B may each be used to view and adjust various action plans 124. Generally, the GUIs 126A, 126B each provide the user with an efficient and user-friendly presentation of the material maps (e.g., oil distribution and oil spill pattern change maps) as images and action plans 124 including recommended oil spill operations communicated within the example system 100. The GUIs 126A, 126B may each include multiple customizable frames or views having interactive fields, for selection of regions of interest and/or display of material maps for different regions and time points. The GUIs 126A, 126B can each be any suitable graphical user interface, such as a combination of a generic web browser, intelligent engine, and command line interface (CLI) that processes information and efficiently presents the results to the user visually.

The output reporting system 112 can include a reporting engine 120C, the GUI 126B (dashboard), an interface 116D, and a processor 118D. The reporting engine 120C utilizes the analytics data provided by the action plan engine 120B to produce executive and semi executive level displays for the GUI 126B. The GUI 126B displays a high-level summary of a material map assessment, which provides support for oil spills in addition to key recommended actions for environment and plant safety. The GUI 126B display can facilitate material management and decision makers to modify (operations of) the systems and machines selected for cleaning identified materials.

The data collection system 106 can include multiple imaging sensors 130A and a detection system 130B. The imaging sensors 130A can be within an aerial device 128 (e.g., attached to or included in the aerial device), acquiring samples and data during a flight or a hovering operation. The imaging sensors 130A and the detection system 130B can include any of a hyperspectral sensor, spectroradiometers (e.g., ultraviolet/visible/near infrared/short wave infrared spectroradiometers), a camera, and other types of probes. The processor 118E of the data collection system 106 controls operation of the imaging sensors 130A and the detection system 130B and directs collected and determined data to the server system 102 for storage, further analysis, and modelling. The imaging sensors 130A and the detection system 130B can collect remote sensing images of one or more areas of interest below the aerial device 128, such as multispectral images. Further details about the imaging sensors 130A and the detection system 130B and their operation are provided with reference to FIG. 1B.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application particular integrated circuit, a field-programmable gate array, or another suitable component. Generally, each processor 118A, 118B, 118C, 118D, 118E executes instructions and manipulates data for oil spill detection. Each processor 118A, 118B, 118C, 118D, 118E executes a functionality required to monitor remote sensing images associated to an aerial device 128, to monitor and track oil spills.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing images 122 (e.g., remote sensing images and/or dynamic information, and any other appropriate information including oil spill models, and oil cleaning parameters, variables, algorithms, instructions, rules, constraints, or references thereto) associated with the purposes of the server system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single server system 102, a single computing device 104, a single data collection system 106, a single network management system 110, the example system 100 can be implemented using a single, stand-alone computing device, two or more core systems 102, or multiple client devices. The server system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the server system 102 and the computing device 104 and the output reporting system 112 may be adapted to execute any operating system or runtime environment. According to one implementation, the server system 102 may also include or be communicably coupled with an e-mail server, a Web server, a caching server, a streaming data server, and/or another suitable server, as described with reference to FIG. 1B.

FIG. 1B is a block diagram of a portion of the example system 100 that can be used to execute implementations of the present disclosure. In particular, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the data collection system 106, a detection and classification system 120A, and an output reporting system 112.

The data collection system 106 includes imaging sensors 130A, a data collection system 130B, and an image preprocessing system 130C. The imaging sensors 130A can be coupled to the aerial device 128 and can be displaced to capture remote sensing images of multiple regions of interest. The imaging sensors 130A and the detection system 130B are communicatively connected to the processor 118E. The imaging sensors 130A can include red, green, blue (RGB) imaging devices, aerial sensors, and hyperspectral sensors (e.g., infrared imaging spectrometers), or other imaging systems facilitating the collection of remote sensing images. The data collection system 130B can generate triggers according to a particular schedule to control data collection executed by the imaging sensors 130A. The data collection system 130B can receive the remote sensing images collected by the imaging sensors 130A and transmit them to the image preprocessing system 130C for pre-processing.

The image preprocessing system 130C executes pre-processing of remote sensing images that can enhance data quality and can ensure accurate downstream analysis. The image preprocessing can include applying geometric alignments to the remote sensing images to generate aligned images and applying radiometric corrections to the aligned images to generate corrected images. geometric alignments and radiometric corrections. The image preprocessing can include: noise correction to remove sensor noise using correction coefficients during image processing; vignetting correction to address uneven illumination across the image caused by lens vignetting; lens distortion correction to apply distortion models to correct lens-induced distortions; band registration to align spectral bands to ensure consistent spatial information; and radiometric correction to normalize pixel values to account for variations in sensor sensitivity. For aerial sensors attached to unmanned aerial vehicles, the pre-processing steps optimize data quality, enabling accurate oil distribution monitoring and tracking applications.

The detection and classification system 120A includes an artificial intelligence (AI) model for oil spill identification and tracking 132A and an oil spill map generator 132B. The AI model for oil spill identification and tracking 132A includes a machine learning model that is based on machine learning techniques including neural networks (e.g., deep neural network (DNN)) and random forests. Machine learning models can identify oil accumulation in various environments, such as within or nearby industrial facilities including oilfields. The AI model for oil spill identification and tracking 132A can classify oil spill type (e.g., critical, moderate, or minor) based on the detected volume, location, and impact on environment and assets. For example, images of oil spills captured using dynamic image analysis can be analyzed using machine learning algorithms to classify them with high accuracy. In an example, a DNN of the subject technology can generate dynamically adjusted oil spill estimates. The DNN model can represent the relationship between remote sensing images collected by the data collection system 106 at multiple time points and the changes in oil distribution within a region of interest.

In one or more implementations, relationships the images collected by the data collection system 106, and metadata can be determined during training of the DNN. The training step optimizes the weights and biases in a hidden and an output layer of the DNN such that the estimation error between the estimated changes in oil distribution within a region of interest and observed changes in oil distribution (e.g., confirmed using terrain measurements) can be minimized. Estimation error can be root mean square deviation, or a composite of root mean square deviation, cross-correlation, or a geoscience error metric. To avoid overfitting during training, regularization of the estimation error is performed based upon the norms of weights in the hidden layers that are added to the estimation error. An optimization process can include application of a stochastic gradient descent algorithm (or any other appropriate optimization algorithm), which can use one or more iterative optimization techniques and/or use a small subset of the training dataset or batch with training samples randomly selected at a time. The variances calculated based upon the horizontal and vertical semi-variograms are included in the input feature. The optimization process can optimize the weights and biases associated with the vertical and horizontal semi-variances, and other input features such that an error in the property estimates relative to the observed oil distribution values can be minimized. The process of training described here not only can minimize the error in oil distribution estimates, but also can incorporate oil amount variance relative to one or more reference points (e.g., road mapping and/or industrial facilities). Following the completion of training that can be determined by the estimation error on the validation dataset falling below a cut-off value, the remote sensing images and corresponding metadata can be used to determine the performance of the trained DNN on unseen remote sensing images (e.g., not used for training). The trained DNN provides the ability of identifying pattern changes of the oil spills based on the estimated oil amount and one or more initial oil spill patters. Although a DNN was discussed for the purposes of explanation, it is appreciated that the AI model for oil spill identification and tracking 132A can include other trainable machine learning techniques. Further, it is appreciated that other types of neural networks can be utilized by the subject technology. For example, a convolutional neural network, regulatory feedback network, radial basis function network, recurrent neural network, modular neural network, instantaneously trained neural network, spiking neural network, regulatory feedback network, dynamic neural network, neuro-fuzzy network, compositional pattern-producing network, memory network, and/or any other appropriate type of neural network can be utilized.

In some implementations, the AI model for oil spill identification and tracking 132A includes transformer-based architectures. The transformer-based architectures can use a Siamese vision transformer (SViT) to establish global semantic relations and model long-range context. SViT is configured to handle noisy changes induced by environmental variations, making it robust for detecting significant changes in oil distribution. The transformer-based architectures can use a Scratch Former model that is configured for remote sensing change detection. The transformer-based architectures can use a shuffled sparse attention mechanism to focus on sparse informative regions, which is crucial for detecting changes in oil distribution. The transformer-based architectures can incorporate a change-enhanced feature fusion module to improve the detection of relevant oil spills while reducing noise. The transformer-based architectures can use a change former architecture that combines a hierarchically structured transformer encoder with a multi-layer perceptron (MLP) decoder in a Siamese network. The change former architecture captures multi-scale long-range details, which provide accurate change detection in oil distribution. The transformer-based architectures can use dual cross-attention transformer model that uses a hybrid dual-branch mixer that combines convolution and transformer techniques to extract and fuse local and global features of oil distribution changes. The dual cross-attention transformer model calculates cross-attention features to learn comprehensive cues from paired images, making it effective for oil spill detection. The transformer-based models offer advanced capabilities for accurately detecting and monitoring changes in oil distribution, leveraging long-range dependencies and handle noisy data effectively.

In some implementations, the AI model for oil spill identification and tracking 132A can classify oil spill patterns into one of multiple categories. The AI model for oil spill identification and tracking 132A can include a machine learning model that is based on machine learning techniques including neural networks (e.g., DNN) and clustering algorithms. The machine learning techniques can be trained to classify oil spill patterns using labeled oil spill patterns. In some implementations, clustering algorithms for oil spill pattern classification include K-means clustering algorithm partitions data into (k) clusters by minimizing the sum of squared distances between data points and the respective cluster centroids. The K-means clustering algorithm can use as an input a predefined number of clusters. In some implementations, clustering algorithms for oil spill pattern classification include hierarchical clustering that builds a hierarchy of clusters by either merging smaller clusters into larger ones (agglomerative) or splitting larger clusters into smaller ones (divisive), providing information about the data structure at different levels of granularity. In some implementations, clustering algorithms for oil spill pattern classification include density-based clustering (DBSCAN) that groups together points that are closely packed together, marking points that are in low-density regions as outliers. DBSCAN can be particularly effective for datasets with noise and varying densities. In some implementations, clustering algorithms for oil spill pattern classification include spectral clustering that uses the eigenvalues of a similarity matrix to reduce dimensionality before clustering in fewer dimensions. The spectral clustering can be applied to complex data structures that are not well-separated in the original space. In some implementations, clustering algorithms for oil spill pattern classification include density peak clustering (DPC) to identify cluster centers as points with higher local density than their neighbors and are far from each other. The DPC model can be effective for identifying clusters of varying shapes and densities. The clustering algorithms can help in analyzing and classifying oil spill patterns by identifying distinct clusters of movement based on various features such as velocity, direction, and frequency of movement.

The oil spill map generator 132B can include a system configured to format the outcome of the AI model for oil spill identification and tracking 132A in a displayable format. For example, a multidimensional matrix generated by the AI model for oil spill identification and tracking 132A can be converted by the oil spill map generator 132B into an image. The oil spill map generator 132B can include one or more reference points within the image to enable a visualization of the oil spill within the region of interest relative to the reference points. The oil spill map generator 132B can transmit the generated images of the oil spill to the output reporting system 112. The oil spill map generator 132B can include a masking engine to apply a filter mask to enhance the oil spill map.

The output reporting system 112 includes an automatic risk assessment system 134A, an output data system 134B, an action triggering system 134C, and a machine 134D. The automatic risk assessment system 134A can process the oil variation patterns and most recently generated maps of oil distribution to determine risks associated to one or more points of interests (e.g., roads, industrial plants, oil drilling platforms, and processing systems, etc.). The output data system 134B can include a GUI (e.g., GUI 126 described with reference to FIG. 1A) to generate displays indicating the identified risk. The action triggering system 134C can receive the determined risk, classify the risk (e.g., low, medium, or high) and, based on the classification, generate a trigger to send to the machine 134D to perform a remedial action (e.g., cleaning or relocation of material within the region of interest to protect the one or more points of reference).

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

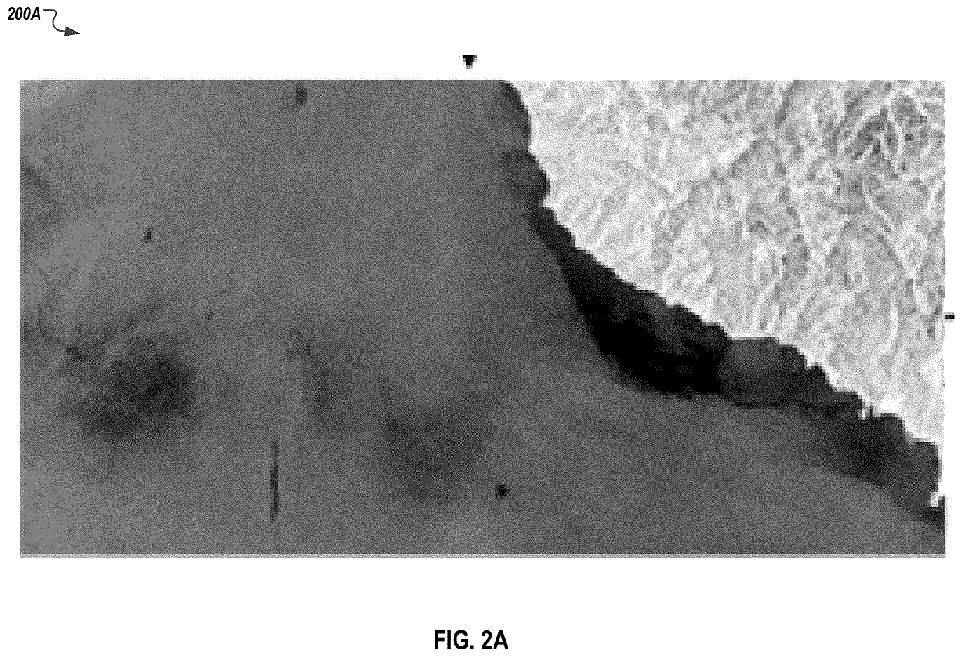

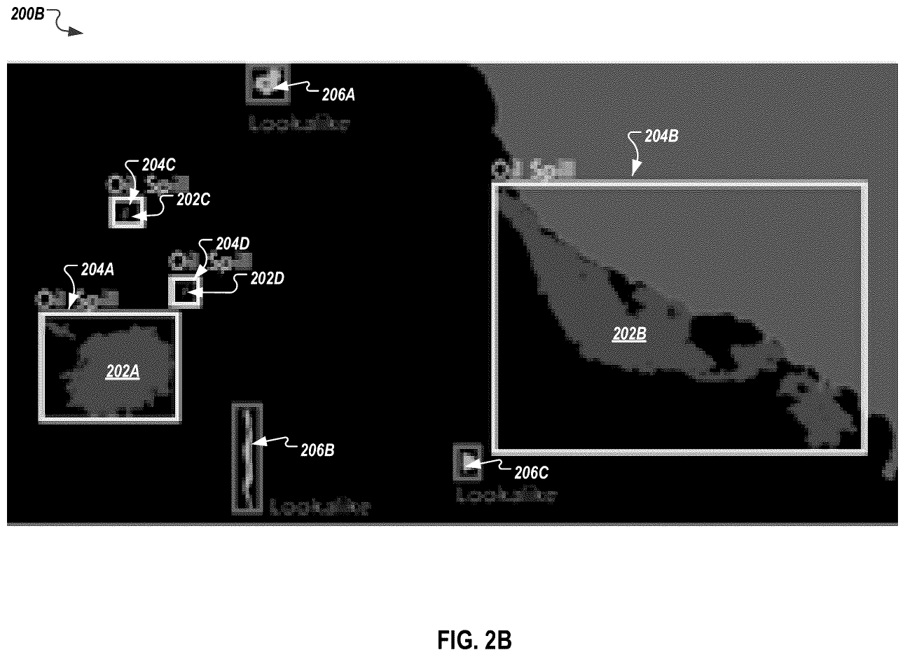

FIG. 2A illustrates an example of an aerial image 200A acquired at a particular time point, according to some implementations of the present disclosure. The example aerial image 200A includes a multi- or hyperspectral image. The example aerial image 200A can include hyperspectral imagery to provide detailed spectral information, facilitating identification of oil and respective unique signatures. The example aerial image 200A can have N=W*H pixels (with width W and height H), with each pixel having an associated spectrum consisting of C “channels” (or “bands”, or “dimensions”). For example, example aerial image 200A can include 1,262×1,533=1,934,646 pixels with 12 bands. The example of a multi- or hyperspectral image 200A can be captured by aerial sensors that generate data in a few wavelength bands (e.g., 3 to 10 bands), such as red, green, blue, near infrared, and short-wave infrared. The bands can have descriptive titles and a spatial resolution of 30 meters (except for a few particular bands). The example aerial image 200A can help identify oil spills at the respective time point it was collected.

FIG. 2B illustrates an example output data 200B including detected oil spills 202A, 202B, 202C, 202D and movement patterns, according to some implementations of the present disclosure. The example output data 200B can include a grayscale or color-coded representation of the variability of the oil spill around each pixel at a particular time point. The example output data 200B represents magnitude of oil spill amount changes around each pixel using shades of gray, ranging from 0 (black) to 255 (red). The grayscale representation of spectral variability of the example output data 200B illustrates local oil distribution variations, oil spill boundaries, and oil spill patterns. Local variations of the example output data 200B can include darker areas that indicate regions with low oil spill amounts and minimal oil spill amount changes. Brighter (red) areas of the example output data 200B correspond to regions with high oil spill amounts or variability, where neighboring pixels exhibit significant differences in the oil distribution variations. The boundaries of the oil spill within the example output data 200B can be defined by oil distribution boundaries and/or transitions. For example, the boundary between areas with high and low oil spill amounts may appear as a distinct edge in the grayscale representation. Texture and patterns of the example output data 200B can include fine-scale texture and patterns within an image that become visible. The appearance of the example output data 200B depends on the type of input data (e.g., hyperspectral data), the time difference between the collected input data, and the context of the input data, as described with reference to FIG. 2A. The example output data 200B can include highlights 204A-204D (e.g., frames or circular markers) around identified oil spills and markers 204 indicative of locations of points of interest 206A-206C within the area of interest.

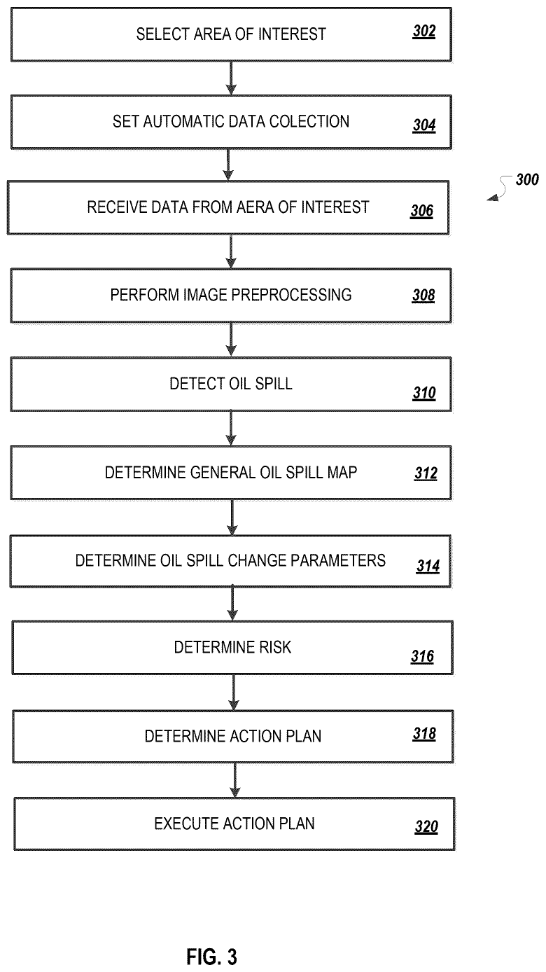

FIG. 3 depicts a flowchart illustrating an example process 300 for oil spill pattern detection algorithms for aerial image processing, in accordance with some example embodiments. Referring to FIGS. 1A and 1B, the example process 300 can be performed by any components of the example systems 100, 101.

At 302, an area (region) of interest is selected, by one or more processors. The area of interest can be selected by setting the area of interest by either setting a bounding box in the map or by defining top left and bottom right coordinates. The area of interest can be chosen according to previous reported spills accidents, areas where is likely to occur an oil spill, or any other area that requires supervision. For example, the area of interest can be selected based on a monitoring plan of one or more points of interest. The points of interest can include industrial plants, industrial equipment, access points (roads, helipads, launching pads) to industrial plants and/or industrial equipment.

At 304, an automatic data collection schedule is set and implemented, by the one or more processors. The automatic data collection schedule can define multiple time points to collect remote sensing images of an area of interest. The automatic data collection schedule can define aerial image collection within short-time intervals or long-time intervals. In some implementations, the automatic data collection schedule can define a normal operational mode of low data collection frequency and an event associated operational mode of high data collection frequency. The sensors collecting data including remote sensing images can be set to operate in the normal operational mode and switch to the event associated operational mode in response to receiving an indicator of an upcoming or ongoing event (e.g., weather event, such as storm).

At 306, data received, by the one or more processors, from sensors monitoring a region of interest is processed to generate fused data. The data includes aerial images, metadata, and meteorological data. The aerial image can be received from a satellite, or an aerial device (e.g., aerial device 128 described with reference to FIG. 1A) equipped with an aerial image acquisition device (e.g., hyperspectral, multispectral, synthetic aperture radar or optical). A typical multi- or hyperspectral image (e.g., example aerial image 200A) can have N=W*H pixels (with width W and height H), with each pixel having an associated spectrum consisting of C “channels” (or “bands”, or “dimensions”). The set of spectra associated with the pixels can be represented as vectors in a multi-dimensional (e.g., 12-dimensional) space, where oil (and other materials) with similar spectra can form clusters of high density. The aerial image can be processed to obtain one or two-dimensional cross sections showing the first two principal components of the 12-dimensional spectral vector space. Every point in the scatterplot can corresponds to the spectrum of a vector associated with a pixel in the original aerial image. The set of spectra associated with the pixels can be represented as a scatterplot including vectors in a 12-dimensional space, where materials with similar spectra can form clusters of high density. Every point in the scatterplot corresponds to the spectrum of a vector associated with a pixel in the original image. The metadata can provide information about the collected aerial images. The metadata can include geospatial information, such as coordinates: latitude and longitude of the image corners or center and projection information, such as details about the map projection used, such as the geodetic datum and coordinate system. The metadata can include temporal information, such as acquisition date and time defining when the image was captured, often including the exact timestamp. The metadata can include sensor information, such as sensor type indicating the type of sensor used (e.g., optical, radar) and sensor angles, such as angles at which the sensor captured the image, including azimuth and elevation angles. The metadata can include radiometric information, such as resolution including spatial resolution (e.g., 10 meters per pixel) and spectral resolution (e.g., number of bands and their wavelengths). The metadata can include calibration data, such as information needed to convert raw data into meaningful physical quantities. The metadata can include environmental conditions, such as solar angles: position of the sun at the time of image capture, including solar azimuth and elevation. The metadata can include weather conditions, such as information about atmospheric conditions, such as cloud cover. The metadata can include image quality, such as noise levels indicating data on the amount of noise present in the image. The metadata can include compression artifacts, such as information on any compression applied to the collected aerial images. The meteorological data can include ongoing or predicted precipitation and wind intensity and direction. The meteorological data can enable tracking of oil spills over time relative to the meteorological data to identify risks of affecting points of interest and potential effects on remedial actions. The fused data includes integrated information extracted from the aerial images, the corresponding metadata, and the corresponding meteorological data.

At 308, preprocessing can be applied, by the one or more processors, to the fused data to generate preprocessed data. The image preprocessing can perform rectifications or modifications as required by the input of the detection system. In some implementations, image preprocessing can include applying geometric alignments to the remote sensing images to generate aligned images and applying radiometric corrections to the aligned images to generate radiometric corrected images. The geometric correction correct distortions in the image caused by the sensor's perspective, earth's curvature, and terrain variations. Geometric corrections generate corrected images that accurately represent the earth's surface. Geometric correction include: orthorectification including adjusting the image to remove distortions caused by the sensor's angle and the earth's topography, aligning it with a map coordinate system; and georeferencing including assigning real-world coordinates to the image pixels, often using ground control points to match the image with known locations on the earth's surface. Radiometric correction addresses variations in the image's pixel values caused by atmospheric conditions, sensor noise, and illumination differences. The radiometric correction process facilitate the pixel values to accurately reflect the true radiance or reflectance of the earth's surface. Radiometric correction includes: atmospheric correction including removing the effects of atmospheric scattering and absorption to retrieve the true surface reflectance; sensor calibration including correcting for sensor-specific biases and noise to ensure consistent and accurate measurements across different images and sensors; normalization including adjusting the image to account for differences in illumination and viewing geometry, ensuring that images taken at different times or under different conditions are comparable. The described preprocessing facilitate oil distribution classification, oil spill change detection, and oil spill tracking, where accurate and consistent data is essential. The metadata and the meteorological data can be preprocessed to filter data irrelevant for oil spill detection.

At 310, oil spill is detected, by the one or more processors, using an artificial intelligence model. The artificial intelligence model can be trained to identify oil spills within the area of interest by processing preprocessed data. For example, the artificial intelligence model receives as input fused data including radiometric corrected images, respective metadata indicative of the data collection time, and meteorological data corresponding to the region of interest. The artificial intelligence model can timely identify and detect onshore areas with oil spills, predict the spread direction, and classify the pollutant type based on a concentration of components, such as light, medium and heavy chemicals (e.g., benzene, xylene, toluene, and ethylbenzene). In some implementations, the changes in oil distribution within both short time intervals and longtime intervals are determined. The artificial intelligence model can be a machine learning model configured to identify, detect, classify, and predict changes in oil distribution within the area of interest. The artificial intelligence model can include any of a neural network (e.g., DNN as described with reference to FIG. 1B), long short-term memory networks (e.g., recurrent neural network), random forests, and clustering algorithms to identify oil spill changes over time from radiometric corrected images. The machine learning techniques can be trained to classify oil spill patterns using labeled oil spill patterns. The training of the artificial intelligence model can be done using real (previously recorded) or synthetic generated fused data. The training of the artificial intelligence model can be performed using techniques such as transfer-learning, multi-task learning, continual learning, supervised learning, un-supervised learning, or domain-adaptation. In some implementations, clustering algorithms for oil spill pattern classification include K-means clustering algorithm partitions data into (k) clusters by minimizing the sum of squared distances between data points and the respective cluster centroids. The K-means clustering algorithm can use as an input a predefined number of clusters. In some implementations, clustering algorithms for oil spill pattern classification include hierarchical clustering that builds a hierarchy of clusters by either merging smaller clusters into larger ones (agglomerative) or splitting larger clusters into smaller ones (divisive), providing information about the data structure at different levels of granularity. In some implementations, clustering algorithms for oil spill pattern classification include density-based clustering (DBSCAN) that groups together points that are closely packed together, marking points that are in low-density regions as outliers. DBSCAN can be particularly effective for datasets with noise and varying densities. In some implementations, clustering algorithms for oil spill pattern classification include spectral clustering that uses the eigenvalues of a similarity matrix to reduce dimensionality before clustering in fewer dimensions. The spectral clustering can be applied to complex data structures that are not well-separated in the original space. In some implementations, clustering algorithms for oil spill pattern classification include density peak clustering (DPC) to identify cluster centers as points with higher local density than their neighbors and are far from each other. The DPC model can be effective for identifying clusters of varying shapes and densities. The clustering algorithms facilitate analysis and classification of oil spill patterns by identifying distinct clusters of movement based on various features such as velocity, direction, and frequency of movement. In some implementations, the artificial intelligence model and the second artificial intelligence models are combined to perform the change detection and classification as a single processing procedure.

At 312, a general oil spill map is determined, by the one or more processors. The general oil spill map can include a spatial distribution of an oil spill amount variability index throughout the area of interest. The oil spill amount variability index can be calculated for each pixel in the radiometric corrected image. The general oil spill map can include the points of interest within the area of interest to facilitate an evaluation of the oil distribution over time relative to a distance to the points of interest. The general oil spill map can include highlights and/or markers to flag portions of the area of interest including oil spills.

At 314, oil spill change parameters are determined, by the one or more processors. The oil spill change parameters can be determined by applying segmentation masks, bounding boxes, and classification labels with confidence scores, change maps, or regression values. The oil spill segmentation masks can include multi-scale feature map fusion, segment anything model (SAM) oil framework, or mask region-based convolutional neural network (R-CNN) model. The multi-scale feature map fusion method enhances segmentation accuracy by reintroducing rich semantic contextual information before obtaining the final segmentation mask. The multi-scale feature map fusion uses a multi-convolutional layer module to extract basic features from images (e.g., oil spill maps) and a feature extraction module to fuse feature maps at different levels. The SAM-oil framework combines an object detector with an adapted segment anything model and an ordered mask fusion module. The SAM-oil framework effectively segments oil spills by using bounding boxes to retrieve category-agnostic masks and resolving pixel category conflicts. The mask R-CNN model is used for instance segmentation, marking oil spill boundaries at the pixel level. Bounding boxes are applied to oil spill maps for oil spill change detection and classification of categorize oil spill-related objects. The bounding boxes can be used to retrieve category-agnostic masks through an adapted segment anything model, which helps in accurately segmenting the oil spill areas. The bounding boxes can be applied using anchor-free approaches to avoid traditional anchor-based bounding boxes and instead directly detect the position and size of oil spills. The oil spill change parameters can be stored in a database (e.g., memory 114A described with reference to FIG. 1A) for further analysis, dataset collection for training and/or for historical analysis. In some implementations, the variations of the oil spill parameters over time are used to generate oil spill change maps. The oil spill change map can include a map of oil spill patterns that can include highlights (e.g., frames or circular markers) around identified changed oil spills. The oil spill change map can include one or more reference points within the image to enable a visualization of the oil spill patterns within the region of interest relative to the reference points. The oil spill pattern map can be transmitted an output reporting system (e.g., output reporting system 112 described with reference to FIGS. 1A and 1B) for display.

At 316, a risk is determined, by the one or more processors. The risk can be determined by performing a temporal variation of materials over the region of interest relative to a distance to a point of interest. For example, changes in the oil accumulation amount in temporally separated images of the same region can be used for change detection, monitoring and object/materials tracking and oil spill patterns. The temporal variation analysis can be applied to scan large regions either domestically or globally for large scale mapping, safety, and security relative to a risk of disrupting operation of equipment due to oil spill patterns (e.g., oil spill spread direction relative to timeline).

At 318, an action plan defining an action and a corresponding surface equipment is determined, by the one or more processors. The action plan can be identified by machine learning models (e.g., recurrent neural networks with a multi-layer network topology) trained and fine-tuned to generate an automatic selection of an efficient remedial action (e.g., activation of one or more cleaning machines or deactivation of one or more systems for safety and protection of an environment and an industrial plant). The surface equipment can be selected to match the characteristics of the oil spill pattern and execute the intended oil cleaning or removal operations. The trained machine learning models can be configured to operate in active mode, for oil spill pattern identification, facilitating automatic action plan implementation. For example, the trained machine learning models can trigger an initiation of the action plan, and a modification of surface equipment operations based on most recent maps of oil spill patterns relative to the predicted oil spill patterns and ongoing or expected events.

At 320, the action plan is automatically executed by generating a trigger, by the one or more processors, to activate an operation of a system or a machine configured to perform a remedy operation (e.g., cleaning or oil removal operation). The operation of the system or the machine can include initiation of a transport or (self-) driving operation of the cleaning machinery to the region of interest and activation of a cleaning module of the machine. The cleaning machinery can be configured to execute cleaning up onshore oil spills using techniques suited to different conditions and a type of the detected oil. For example, the cleaning machinery can execute shoreline flushing that uses water to remove or refloat stranded oil, making it easier to recover as a slick on the water. As another example, the cleaning machinery can include large industrial vacuums that can suction oil off the terrain (e.g., beach or shoreline vegetation). As another example, the cleaning machinery can apply sorbent materials, such as pads or booms, designed to absorb oil but not water. As another example, the cleaning machinery can execute mechanical removal using heavy machinery to physically remove contaminated soil and debris. As another example, the cleaning machinery can apply bioremediation that uses microorganisms to break down and degrade oil into less harmful substances. The action plan execution can include generation of an alert to indicate a risk associated with the spread direction of the oil spill. The spread direction can be determined based on segmentation masks and based on a change detection within the oil spill pattern map. The spread direction can define a (substantially horizontal) direction, in which a front line of the oil spill surface is propagating.

The example process 300 facilitates optimization of accurate generation of oil spill pattern map. One of the greatest benefits of generation of an accurate material map is that it facilitates activation of automatic remedial machine actions to ensure continuous workflows and access to facilities. The example process 300 enhances a characterization of regions of interest, providing resource conservation opportunities by minimizing computing system requirements and optimization of monitorization of large oil spills.

In some implementations, customized user interfaces can present intermediate or final results of the above-described processes on a user interface of a user device. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, material management associated with overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period-of-time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. The described technology can be especially useful for systems or various pieces of equipment that are located several meters or several miles apart or are located in different countries or other jurisdictions.

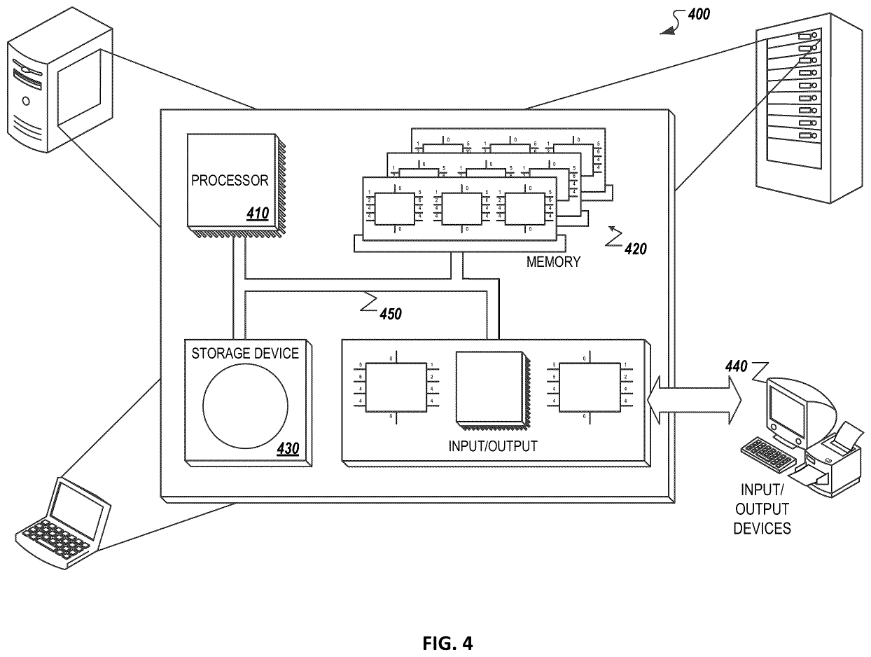

FIG. 4 depicts a block diagram illustrating a computing system 400, in accordance with some example embodiments. Referring to FIGS. 1A and 1B, the computing system 400 can be used to implement the server system 102 and/or any other components of the example system 100.

As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the example system 100. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 can provide persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1. A computer-implemented method comprising: receiving data corresponding to a region of interest, the data comprising remote sensing images of the region of interest and respective metadata, the region of interest being within an onshore zone; integrating the remote sensing images of the region of interest and the respective metadata with meteorological data to generate fused data; determining, by processing the fused data, using an artificial intelligence model, features of an oil spill; and identifying an action plan to remedy an effect of the oil spill based on the features of the oil spill.
Example 2. The computer-implemented method of the preceding example, wherein the features of the oil spill comprise spread direction and pollutant type.
Example 3. The computer-implemented method of any of the preceding examples, wherein identifying the action plan comprises determining a risk associated with the spread direction; and generating an alert indicative of the risk associated with the spread direction.
Example 4. The computer-implemented method of any of the preceding examples, wherein the spread direction is determined based on segmentation masks and based on change detection.
Example 5. The computer-implemented method of any of the preceding examples, wherein the remote sensing images comprise satellite and/or drone Optical, SAR, InSAR, IR, and Multi/Hyperspectral images.
Example 6. The computer-implemented method of any of the preceding examples, wherein the artificial intelligence model is trained using historical data or synthetic generated data along with techniques comprising transfer-learning, multi-task learning, continual learning, supervised learning, un-supervised learning, or domain-adaptation.
Example 7. The computer-implemented method of any of the preceding examples, wherein the effect of the oil spill is determined relative to one or more points of interests and wherein identifying the action plan to remedy the effect of the oil spill comprises activating an equipment to clean or protect the one or more points of interests.
Example 8. A computer-implemented system comprising: memory storing application programming interface (API) information; and a server performing operations comprising: receiving data corresponding to a region of interest, the data comprising remote sensing images of the region of interest and respective metadata, the region of interest being within an onshore zone; integrating the remote sensing images of the region of interest and the respective metadata with meteorological data to generate fused data; determining, by processing the fused data, using an artificial intelligence model, features of an oil spill; and identifying an action plan to remedy an effect of the oil spill based on the features of the oil spill.
Example 9. The computer-implemented system of the preceding example, wherein the features of the oil spill comprise spread direction and pollutant type.
Example 10. The computer-implemented system of any of the preceding examples, wherein identifying the action plan comprises determining a risk associated with the spread direction; and generating an alert indicative of the risk associated with the spread direction.
Example 11. The computer-implemented system of any of the preceding examples, wherein the spread direction is determined based on segmentation masks and based on change detection.
Example 12. The computer-implemented system of any of the preceding examples, wherein the remote sensing images comprise satellite and/or drone Optical, SAR, InSAR, IR, and Multi/Hyperspectral images.
Example 13. The computer-implemented system of any of the preceding examples, wherein the artificial intelligence model is trained using historical data or synthetic generated data along with techniques comprising transfer-learning, multi-task learning, continual learning, supervised learning, un-supervised learning, or domain-adaptation.
Example 14. The computer-implemented system of any of the preceding examples, wherein the effect of the oil spill is determined relative to one or more points of interests and wherein identifying the action plan to remedy the effect of the oil spill comprises activating an equipment to clean or protect the one or more points of interests.
Example 15. A non-transitory computer-readable media encoded with a computer program, the computer program comprising instructions that when executed by one or more computers cause the one or more computers to perform operations comprising: receiving data corresponding to a region of interest, the data comprising remote sensing images of the region of interest and respective metadata, the region of interest being within an onshore zone; integrating the remote sensing images of the region of interest and the respective metadata with meteorological data to generate fused data; determining, by processing the fused data, using an artificial intelligence model, features of an oil spill; and identifying an action plan to remedy an effect of the oil spill based on the features of the oil spill.
Example 16. The non-transitory computer-readable media of the preceding example, wherein the features of the oil spill comprise spread direction and pollutant type.
Example 17. The non-transitory computer-readable media of any of the preceding examples, wherein identifying the action plan comprises determining a risk associated with the spread direction; and generating an alert indicative of the risk associated with the spread direction.
Example 18. The non-transitory computer-readable media of any of the preceding examples, wherein the spread direction is determined based on segmentation masks and based on change detection.
Example 19. The non-transitory computer-readable media of any of the preceding examples, wherein the remote sensing images comprise satellite and/or drone Optical, SAR, InSAR, IR, and Multi/Hyperspectral images.
Example 20. The non-transitory computer-readable media of any of the preceding examples, wherein the artificial intelligence model is trained using historical data or synthetic generated data along with techniques comprising transfer-learning, multi-task learning, continual learning, supervised learning, un-supervised learning, or domain-adaptation and wherein the effect of the oil spill is determined relative to one or more points of interests and wherein identifying the action plan to remedy the effect of the oil spill comprises activating an equipment to clean or protect the one or more points of interests.

What is claimed is:

1. A computer-implemented method comprising:
receiving data corresponding to a region of interest, the data comprising remote sensing images of the region of interest and respective metadata, the region of interest being within an onshore zone;
integrating the remote sensing images of the region of interest and the respective metadata with meteorological data to generate fused data;
determining, by processing the fused data, using an artificial intelligence model, features of an oil spill; and
identifying an action plan to remedy an effect of the oil spill based on the features of the oil spill.

2. The computer-implemented method of claim 1, wherein the features of the oil spill comprise spread direction and pollutant type.

3. The computer-implemented method of claim 2, wherein identifying the action plan comprises:
determining a risk associated with the spread direction; and
generating an alert indicative of the risk associated with the spread direction.

4. The computer-implemented method of claim 2, wherein the spread direction is determined based on segmentation masks and based on change detection.

5. The computer-implemented method of claim 1, wherein the remote sensing images comprise satellite and/or drone Optical, SAR, InSAR, IR, and Multi/Hyperspectral images.

6. The computer-implemented method of claim 1, wherein the artificial intelligence model is trained using historical data or synthetic generated data along with techniques comprising transfer-learning, multi-task learning, continual learning, supervised learning, un-supervised learning, or domain-adaptation.

7. The computer-implemented method of claim 1, wherein the effect of the oil spill is determined relative to one or more points of interests and wherein identifying the action plan to remedy the effect of the oil spill comprises activating an equipment to clean or protect the one or more points of interests.

8. A computer-implemented system comprising:
memory storing application programming interface (API) information; and
a server performing operations comprising:
receiving data corresponding to a region of interest, the data comprising remote sensing images of the region of interest and respective metadata, the region of interest being within an onshore zone;
integrating the remote sensing images of the region of interest and the respective metadata with meteorological data to generate fused data;
determining, by processing the fused data, using an artificial intelligence model, features of an oil spill; and
identifying an action plan to remedy an effect of the oil spill based on the features of the oil spill.

9. The computer-implemented system of claim 8, wherein the features of the oil spill comprise spread direction and pollutant type.

10. The computer-implemented system of claim 9, wherein identifying the action plan comprises:
determining a risk associated with the spread direction; and
generating an alert indicative of the risk associated with the spread direction.

11. The computer-implemented system of claim 9, wherein the spread direction is determined based on segmentation masks and based on change detection.

12. The computer-implemented system of claim 8, wherein the remote sensing images comprise satellite and/or drone Optical, SAR, InSAR, IR, and Multi/Hyperspectral images.

13. The computer-implemented system of claim 8, wherein the artificial intelligence model is trained using historical data or synthetic generated data along with techniques comprising transfer-learning, multi-task learning, continual learning, supervised learning, un-supervised learning, or domain-adaptation.

14. The computer-implemented system of claim 8, wherein the effect of the oil spill is determined relative to one or more points of interests and wherein identifying the action plan to remedy the effect of the oil spill comprises activating an equipment to clean or protect the one or more points of interests.

15. A non-transitory computer-readable media encoded with a computer program, the computer program comprising instructions that when executed by one or more computers cause the one or more computers to perform operations comprising:
receiving data corresponding to a region of interest, the data comprising remote sensing images of the region of interest and respective metadata, the region of interest being within an onshore zone;
integrating the remote sensing images of the region of interest and the respective metadata with meteorological data to generate fused data;
determining, by processing the fused data, using an artificial intelligence model, features of an oil spill; and
identifying an action plan to remedy an effect of the oil spill based on the features of the oil spill.

16. The non-transitory computer-readable media of claim 15, wherein the features of the oil spill comprise spread direction and pollutant type.

17. The non-transitory computer-readable media of claim 16, wherein identifying the action plan comprises:
determining a risk associated with the spread direction; and
generating an alert indicative of the risk associated with the spread direction.

18. The non-transitory computer-readable media of claim 16, wherein the spread direction is determined based on segmentation masks and based on change detection.

19. The non-transitory computer-readable media of claim 15, wherein the remote sensing images comprise satellite and/or drone Optical, SAR, InSAR, IR, and Multi/Hyperspectral images.

20. The non-transitory computer-readable media of claim 15, wherein the artificial intelligence model is trained using historical data or synthetic generated data along with techniques comprising transfer-learning, multi-task learning, continual learning, supervised learning, unsupervised learning, or domain-adaptation and wherein the effect of the oil spill is determined relative to one or more points of interests and wherein identifying the action plan to remedy the effect of the oil spill comprises activating an equipment to clean or protect the one or more points of interests.
